(19) United States
(12) Patent Application Publication
(10) Pub. No.: US 2006/0287466 A1
(43) Pub. Date: Dec. 21, 2006

(54) Method for production of prepolymers made from polysulphides and polyepoxides

(76) Inventors: Michael Zeitler, Alfter (DE); Nils Kottner, Greiz (DE); Manfred Bergfeld, Erlenbach-Mechenhard (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/555,726

(22) PCT Filed: May 3, 2004
(86) PCT No.: PCT/EP04/04643

§ 371 Date: Feb. 1, 2006

(30) Foreign Application Priority Data
May 7, 2003 (DE) 103 20 543.8

(51) Int. Cl. C08G 59/66

(52) U.S. Cl. 528/103; 528/109

(57) ABSTRACT

A method for the production of prepolymers by reaction of polysulphides with polyepoxides is disclosed, whereby polyepoxides are reacted with polysulphides, having at least two mercapto groups, in the presence of quaternary ammonium compounds as catalyst. The method permits a rapid quantitative reaction and gives uniform products with regard to functionality and the proportion of functional groups per weight unit. The products thus produced have stable, may be stored, may be cured in a very reproducible manner, or may be processed to give products with a defined property profile.

The invention relates to a method for the production of preferably liquid prepolymers starting from polysulfides and polyepoxides, and the prepolymers produced by this method. These prepolymers are produced by reacting polysulfides, for example of the general formula

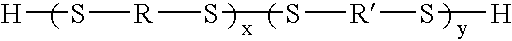

with polyepoxides of the general formula 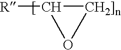
preferably

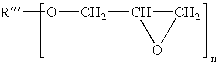

in which n =2 -4.

The production of epoxidized polysulfides, which include the abovementioned prepolymers, has been known per se for a long time. Thus, U.S. Pat. No. 2,789,958 describes a method in which polythiopolythiols of the formula

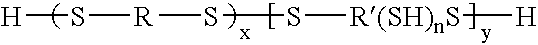

are reacted with a very wide range of polyepoxides.

Since the index x may be 2 and the indices n and y may be zero and mainly bisepoxides are used as polyepoxides, polysulfides which have two terminal epoxy groups are also part of the disclosure of this patent.

However, the products described there and obtained by reacting polyepoxides with polysulfides are not suitable as liquid, stable polymers, as will be explained in more detail below.

The method according to U.S. Pat. No. 2,789,958 can be carried out on the one hand without the presence of catalysts. In this case, a nonuniform mixture forms.

However, according to the teaching of this US patent, the reaction of the epoxides with the polysulfides can also be carried out in the presence of aliphatic amines, such as ethylenediamine, methyldiethanolamine, etc., as a catalyst.

If the procedure is carried out without a catalyst, the reaction takes a disproportionately long time. In the presence of catalysts, a viscous to hard product is obtained.

Chemically uniform products are not obtained in either of the two cases.

A method in which an epoxy resin having an epoxy group content of from 2 to 6 mol/kg is reacted with a polymer having terminal mercaptan groups with at least 2 mercaptan groups per molecule and a molecular weight of not more than 2000 and a curable liquid block copolymer which may be designated as a prepolymer is obtained thereby is described in EP 0 171 198 B1, with reference to U.S. Pat. No. 2,789,958.

The reaction has to be carried out using a stoichiometric excess, i.e. the molar ratio of epoxy groups to mercaptan groups should be in the range from 2:1 to 7.5:1 in the case of epoxy-terminated prepolymers or in the range from 1:1.5 to 1:3 in the case of mercapto-terminated prepolymers.

In addition, the reaction should be carried out in the absence of a catalyst or curing agent.

The prepolymers described there, which may also be referred to as block polymers, are, as stated in this document, fairly viscosity-stable after 1-2 weeks and can be stored only thereafter, but are unsatisfactory with regard to their uniformity. In many cases, it is not possible in this way to carry out specific curing which leads to end products having certain desired properties.

Furthermore, the reaction takes a disproportionately long time. It has in fact been found, as is evident from the examples of EP 0 171 198 B1, that a relatively long time span is required in order to obtain a stable product. Thus, the mercaptan content is decreased to 0 there in example 2 only after storage for one week at 40° C. In example 4, on storage at room temperature, the mercaptan content has decreased to 0 only after 16 days.

Stability in the truest sense of the word is achieved only after weeks, as stated in example 2, where it is said that, on storage at room temperature, the viscosity remains relatively stable only after 36 weeks. For the producer, this means that he has to store his products for a relatively long time, preferably at elevated temperatures, before he can deliver them to customers, which is a major disadvantage in terms of production and logistically.

Although the production of prepolymers having terminal epoxy groups or terminal mercapto groups based on polysulfides has therefore already been disclosed by a number of publications, there is still a need for improved methods for the production of such products, and products having improved properties.

It is therefore an object of the invention to provide a method for the production of prepolymers having terminal epoxy groups or terminal SH groups by reacting polysulfides and polyepoxides, which prepolymers are particularly uniform with regard to their terminal groups and are particularly suitable especially for further processing by means of curing.

It is furthermore an object of the invention to provide prepolymers having terminal epoxy groups or terminal SH groups, by means of which it is possible to produce tailor-made end products having properties defined above.

It is furthermore an object of the invention to provide a method which permits rapid quantitative reaction which can also advantageously take place stoichiometrically according to the schematic equation I or II, i.e. which leads to reactive, purely bifunctional products. 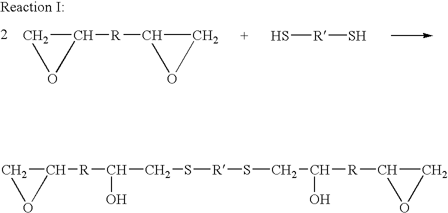
or

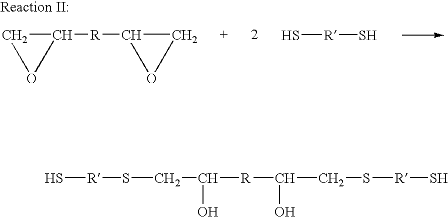

It is furthermore an object of the invention to provide a method for the production of product mixtures having uniform functionality.

If in fact more than 2 mol of bisepoxide are used per mole of mercaptan in the reaction according to equation I, a mixture forms, but one in which the functionality, in this case epoxyfunctionality, is uniform. The same does of course apply in an analogous manner if polyepoxides, for example trisepoxides, are used instead of bisepoxides.

The same applies to the reaction according to equation II. If more than 2 mol of bismercaptan are used here per mole of bisepoxide, a product mixture which is uniform with regard to the terminal groups, i.e. has only terminal mercaptan groups, likewise forms. Of course, what is stated here for the uniformity of the terminal groups also applies when trimercaptan is used instead of bismercaptan.

It is furthermore an object of the invention to provide a method in which not only products having uniform bifunctionality form, but by means of which it is also possible to obtain, in a controlled manner, uniform products which are higher than bifunctional with regard to the mercapto groups or the epoxy groups or contain proportions of trifunctional prepolymers or prepolymers having higher functionality.

This object is achieved by a method for the production of prepolymers by reacting polysulfides with polyepoxides, by reacting polyepoxides with polysulfides which have at least two mercapto groups in the presence of quaternary ammonium compounds as a catalyst.

Compounds of the formula

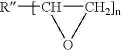

in particular 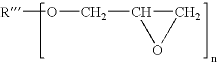
in which n is 2-4 and R″ or R′″ is an organic radical having an aliphatic, aromatic or cycloaliphatic basic structure, are preferably used as polyepoxides.

R′″ or R″ is preferably

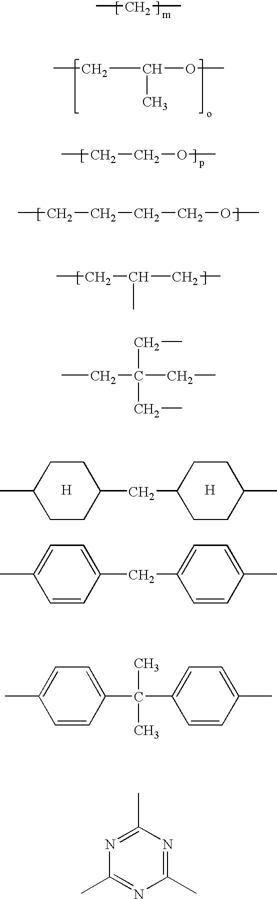

in which m=2-10, o=1-50, p=1-50

It is also possible to use mixtures of the abovementioned epoxides or unmodified epoxy resins and novolacs, such as Epilox® (Leuna resins), bakelite epoxides, such as Rütapox. Araldite resin is also suitable.

Epilox resins (Leuna resins) are marketed, for example, by Leuna-Harz GmbH, D-06237 Leuna, bakelite epoxides, such as Rütapox® resins, by Bakelite AG, D-47125 Duisburg, and araldite resins by Vantico CH-4002 Basle.

Polysulfides used are preferably polysulfides of the following formula

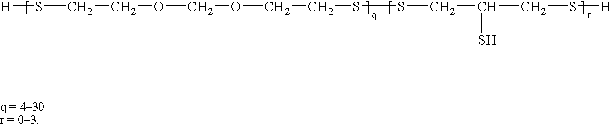

Advantageously, the reaction is carried out in a molar ratio of 1 mol of polysulfide to 2±0.2 mol of polyepoxide in a molar ratio of 1 mol of polyepoxide to 2±0.2 mol of polysulfide, an exact stoichiometric ratio of 1:2 or 2:1 being preferred.

In a particularly advantageous embodiment of the method according to the invention, the starting component determining the functionality of the prepolymer is used in a stoichiometric excess, which may be, for example, up to 2 to 7 times or more.

A preferably used catalyst is methyltrioctylammonium chloride. This product is commercially available as Aliquat 336.

The following may be mentioned by way of example as further quaternary ammonium compounds which may advantageously be used in the context of the invention:
diisobutylphenoxyethoxyethyl-dimethylbenzylammonium chloride,
(diisobutylphenoxyethoxyethyl)dimethylbenzylammonium chloride,
(2-hydroxyethyl)trimethylammonium chloride or benzoate,
benzyldimethyl(2-hydroxyethyl)ammonium chloride,
benzyldimethyldecylammonium chloride.

The catalyst is used in catalytic amounts. The amount is dependent on the chosen reaction temperature and on the reactivity of the epoxides used and can be determined by an average person skilled in the art by simple preliminary experiments. Thus, in general from 0.01 to 0.5% by weight, based on epoxide, is sufficient. Larger or smaller amounts are possible.

Bisphenol A diglycidyl ether and bisphenol F diglycidyl ether and mixtures thereof are particularly suitable as polyepoxide. In addition, polypropylene glycol diglycidyl ether and polyethylene glycol diglycidyl ether and mixtures thereof are very suitable.

In an advantageous embodiment of the method according to the invention, for the production of mercapto-terminated prepolymers, the polysulfide is initially introduced and polyepoxide is metered in. In the case of the production of epoxy-terminated prepolymers, the polyepoxide is initially introduced and polysulfide is metered in.

It is advantageous to meter into a vessel in which the catalyst used is already present. However, it is also possible to meter the catalyst into the vessel while the polysulfide or the polyepoxide is being metered in.

The reaction of the starting materials according to the method according to the invention can be carried out at room temperature, but higher temperatures are preferably employed.

In general, a temperature range of from about 20 to 150° C. is suitable for carrying out the reaction. Preferably a temperature of from 40 to 150, in particular from 40 to 100, preferably from 50 to 70° C. is employed.

It is advantageous to carry out the reaction in vacuo, especially if the starting components still contain traces of moisture. It is furthermore advantageous to stir the reaction mixture during the reaction.

It is of course also possible to introduce the reaction components together with the catalyst directly into a reaction vessel and to allow them to react.

The invention furthermore relates to prepolymers which can be produced by one of the methods stated above.

In contrast to the method which is disclosed in EP 0171198 B1, where the starting components are merely mixed and are allowed to stand at a certain temperature, which generally takes a time of at least two days in order to achieve at least a noticeable conversion, it is surprisingly possible according to the invention to achieve a quantitative conversion within a few hours and to obtain a very uniform, stable product having well defined properties.

The functionality and viscosity achieved after the end of the reaction remain stable. The product can therefore immediately be passed on to the final processor and retains the assured properties unchanged over a long time and can be further processed reproducibly to give products having a defined property profile.

Even if a considerable excess of polyepoxides or of starting materials having terminal mercapto groups is employed, the reaction mixture remains constant after a relatively short reaction time and no longer changes its properties. This makes it possible to produce, in a controlled manner, an end product having a defined content of terminal epoxide or mercapto groups. The prepolymer obtained is thus very uniform with regard to the functional groups, and it is also possible to establish even the proportion of functional groups per unit weight of end product in a controlled manner in wide ranges; it can be very advantageously used in further processing, for example also as an internal plasticizer for corresponding polymers. Moreover, the prepolymer can be cured in an excellent manner using the customary curing agents and thus leads to very uniform cured products.

It is furthermore an excellent binder for finishes, coatings and sealants.

Polyamines, polythiols or other customary compounds having at least two reactive hydrogen atoms can be used as curing agents in the case of prepolymers having terminal epoxy groups.

In the case of prepolymers having terminal mercapto groups, customary oxidizing agents, such as, for example, manganese dioxide, hydrogen peroxide or organic peroxy compounds, are used.

It was furthermore very surprising that it is possible according to the invention exactly to control the reactions of polyepoxides and polysulfides having terminal mercapto groups and to obtain a stable well defined prepolymer in a short time.

In addition, the reaction starts immediately after the combination of the starting components and of the catalyst; the resulting heat can be removed by cooling, so that the temperature during the reaction can be exactly maintained, for example between 50 and 70° C.

It was particularly surprising that it is possible according to the invention exactly to control the reaction of polyepoxides and polysulfides having terminal mercapto groups and to obtain a well defined stable prepolymer in a short time. In the method according to the invention, virtually no further reaction takes place after reaction according to the corresponding equation, and the amount of byproducts obtained is negligible. The prepolymer obtained is thus very uniform and can very advantageously be used in further processing.

The invention is explained in more detail by the following examples.

### EXAMPLE 1

### Epoxy-Terminated Prepolymer

33.4 kg of epoxy resin (Rütapox 0166, equivalent weight 184 g/eq) and 70 g of quaternary ammonium salt Aliquat 336 (methyltrioctylammonium chloride) are initially introduced into a reactor. Thereafter, a vacuum of 50 mbar is applied and the initially introduced mixture is heated to 50° C. 14 kilograms of polysulfide Thioplast G44 from Thioplast Chemicals (equivalent weight 550 g/eq) are then metered in in the course of one hour. After the start of the exothermic reaction, cooling is effected.

The batch is kept at 50 mbar and 50° C. for a further three hours with stirring. After three hours, the reaction is complete. The SH content has fallen below the limit of detection; the viscosity is unchanged even after three months, and the epoxide content too has not changed after three months.

### COMPARATIVE EXAMPLE

The procedure is analogous to example 1, but without the addition of Aliquat 336. After three hours at 50° C., the SH content (starting content 2.0%) is still 1.5% by weight and it is still 0.9% after storage for 3 days at room temperature; after 6 days, the SH content has decreased to 0.12%.

### EXAMPLE 2

### Mercapto-Terminated Prepolymer

In a manner similar to example 1, 2.9 kg of polypropylene glycol diglycidyl ether (Epilox PL 413/42 from Leuna-Harz GmbH, Leuna (equivalent weight 220 g/eq) and 60 g of Aliquat 336 are first initially introduced.

36 kg of polysulfide (Thioplast G 112, equivalent weight 1200 g/eq) are metered in in the course of one hour. The theoretical SH content of the mixture is 2.0%. The reaction starts immediately, heat is evolved and is removed by cooling, and the temperature is kept between 50 and 70° C.

After the end of the metering, a temperature of between 50 and 70° C. is maintained for a further 3 hours with stirring. Cooling to room temperature is then effected. The epoxide content of the end product has decreased below the limit of detection, and the viscosity is unchanged even after three months.

### EXAMPLE 3

### Epoxy-Terminated Prepolymer Mixture

A mixture of 765 kg of epoxy resin Epilox T 1927 (equivalent weight 180 g/eq) and 225 kg of Epilox P 1320 (equivalent weight 150 g/eq) and 0.5 kg of Aliquat 336 is initially introduced and heated to 70° C. Furthermore, with thorough stirring, a vacuum of 50 mbar is and 510 kg of polysulfide G44 are metered in in the course of 5 hours, the temperature being kept at 70° C. The reaction mixture is then kept at a temperature between 70 and 90° C. for a further 4 hours with further stirring. A prepolymer which, after cooling, has a viscosity of 7 Pa·s, a content of SH groups of 0% and an epoxide content of 49% by weight forms. The viscosity of the product is unchanged even after 6 months.

1.-25. (canceled)

26. A method for the production of prepolymers from polysulfides and polyepoxides, comprising the step of reacting polyepoxides with polysulfides which have at least two mercapto groups in the presence of quaternary ammonium compounds as a catalyst at a temperature of 20 - 100° C.

27. The method as claimed in claim 26, characterized in that compounds of the formula 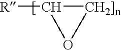
in which n=2-4 and R″ is an organic radical having an aliphatic, aromatic, or cycloaliphatic basic structure, are used as polyepoxides.

28. The method as claimed in claim 26, characterized in that compounds of the formula 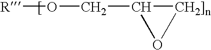
in which n=2-4 and R′″ is an organic radical having an aliphatic, aromatic, or cycloaliphatic basic structure, are used as polyepoxides.

29. The method as claimed in claim 27, characterized in that the organic radical is selected from the group consisting of the following radicals: 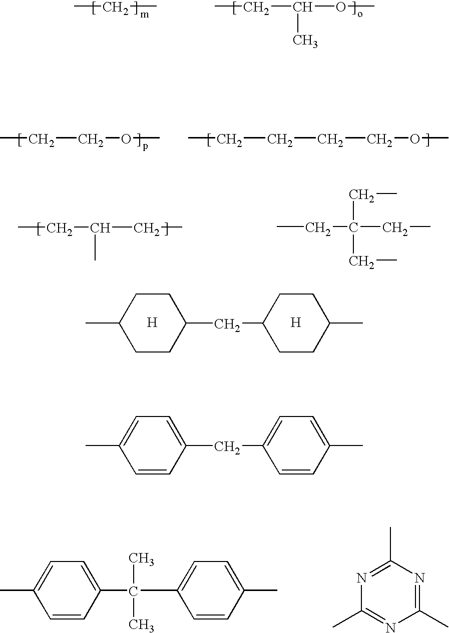
in which m=2-10, o=1-50 and p=1-50.

30. The method as claimed in claim 26, characterized in that the epoxides used are unmodified epoxy resins and novolacs.

31. The method as claimed in claim 26, characterized in that mixtures of epoxides are used.

32. The method as claimed in claim 26, characterized in that polysulfides of the formula 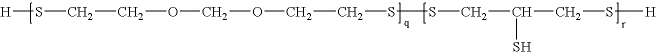
are used, in which q=4-30 and r=0-3.

33. The method as claimed in claim 26, characterized in that the reaction is carried out in a molar ratio of 1 mol of polysulfide to 2±0.2 mol of polyepoxide.

34. The method as claimed in claim 33, characterized in that the reaction is carried out in the stoichiometric ratio 1:2.

35. The method as claimed in claim 26, characterized in that the reaction is carried out in a molar ratio of 2 mol of polysulfide to 1±0.1 mol of polyepoxide.

36. The method as claimed in claim 35, characterized in that the reaction is carried out in a stoichiometric ratio of 2:1.

37. The method as claimed in claim 26, characterized in that the starting component determining the functionality of the prepolymer is used in a stoichiometric excess.

38. The method as claimed in claim 37, characterized in that a 2- to 7-fold stoichiometric excess is used.

39. The method as claimed in claim 26, characterized in that polysulfide is initially introduced and polyepoxide is metered in.

40. The method as claimed in claim 26, characterized in that polyepoxide is initially introduced and polysulfide is metered in.

41. The method as claimed in claim 39, characterized in that metering is effected into a vessel which already contains the catalyst used.

42. The method as claimed in claim 39, characterized in that the catalyst is concomitantly metered into the vessel during the reaction.

43. The method as claimed in claim 26, characterized in that the catalyst used is methyltrioctylammonium chloride.

44. The method as claimed in claim 26, characterized in that the polyepoxide used is bisphenol A diglycidyl ether or bisphenol F diglycidyl ether.

45. The method as claimed in claim 44, characterized in that mixtures of the two polyepoxides are used.

46. The method as claimed in claim 26, characterized in that the reaction is carried out in vacuo, preferably at a pressure of 10-100 mbar.

47. The method as claimed in claim 26, characterized in that the reaction is carried out with stirring.

48. The method as claimed in claim 47, characterized in that the reaction is carried out at a temperature of from 40 to 150° C., in particular 40-100° C.

49. The method as claimed in claim 48, characterized in that the reaction is carried out at temperatures of from 50 to 70° C.

50. A storage-stable prepolymer produced by a method as claimed in claim 26.
